(19) United States
(12) Patent Application Publication
(10) Pub. No.: US 2016/0024844 A1
(43) Pub. Date: Jan. 28, 2016

(54) SAFETY LADDER AND WORK PLATFORM FOR HELICOPTER AND AIRCRAFT MAINTENENCE

(71) Applicant: Dale Martin Neubauer, Bend, OR (US)

(72) Inventor: Dale Martin Neubauer, Bend, OR (US)

(21) Appl. No.: 14/338,741

(22) Filed: Jul. 23, 2014

(51) Int. Cl. E06C 1/38; E06C 1/383; E06C 1/16

(52) U.S. Cl. CPC E06C 1/38; E06C 1/16; E06C 1/383

(57) ABSTRACT

The disclosed lightweight portable ladder provides a stable platform that can nest in close proximity to helicopters, aircraft and other machines to facilitate enhanced access for inspection and maintenance. The ladder consists of a stepped unit connected by hinged means located near the top a support unit and means to hold the units in a fixed orientation. The distance from the hinge point to the bottom of the support unit is longer than from the hinge point to the bottom of the stepped unit. The hinge point may be located some distance below the top of the stepped unit, in which case the upper portion of that unit will be cantilevered with respect to the hinge point. The location of the hinge point can be tailored for specific aircraft and applications so as to provide an optimized fit when the ladder is positioned for use.

### CROSS-REFERENCE TO RELATED APPLICATIONS

This application claims the benefit of provisional patent application Ser. No. 61/857,589, filed Jul. 23, 2013 by the present inventor, the entirety of which is incorporated herein by reference.

### BACKGROUND

1. Field of the Invention

Embodiments of the present invention are generally directed to lightweight moveable safety ladders and work platforms and more specifically to ladders and platforms that can be placed in close proximity to helicopters and aircraft in order to provide human workers with a safe and stable means of accessing, inspecting or servicing those and similar machines.

2. Statement of Prior Art

Aircraft, and most especially helicopters, require regular inspection and maintenance by trained mechanics. In order to gain close access to surfaces, parts or areas higher than can be reached while standing upon the ground, it is necessary to use a ladder or work platform of adequate height.

When work must be performed in the field, on the flight-line or elsewhere where no dedicated stationary platform is available, the mechanic will use a portable platform or ladder. Most frequently a conventional hinged aluminum folding-ladder is used. Such ladders are light in weight, can be carried by a single person and placed adjacent to the helicopter as required. Such ladders, however, are not stable. They can be hazardous when used correctly and dangerous when used incorrectly or when a mechanic is struggling to lift a heavy part or tool.

Furthermore, a conventional folding ladder cannot be positioned relative to the curved body of a helicopter in a manner so that the mechanic is positioned in close proximity to the aircraft. Whether placed parallel to or at an angle to the body of a helicopter, the poor fit of the ladder to the aircraft compromises the ability of the mechanic to perform his work and creates a hazardous condition when he is forced into awkward or unstable positions.

As a helicopter and aircraft mechanic with 26 years of experience, I have yet to come across or use a lightweight, portable ladder or platform that was truly safe, stable and which could be positioned so as to provide the kind of uncompromised access a mechanic requires. One recent design of which I have become aware is a product called the Aircraft MRO Pylon Ladder manufactured by Lock-N-Climb LLC (http://locknclimb.com/pylon-ladder/). This is a light-weight cantilevered aluminum stepladder which bears superficial resemblance to various embodiments of the present invention but which fails to provide a truly safe and stable platform. This ladder appears to be nothing more than a conventional stepladder to which shortened support rails have been attached at about the mid-point of the stepped rails. To partially compensate for the shortness of the support rails, angled extensions have been affixed to the top end of those rails. Such a design is inherently weak and can not provide the high degree of lateral stability needed in a safety work ladder. Furthermore, the support legs will not fold flat against the stepped legs thus making the ladder excessively bulky when in its folded position. The support legs are, of necessity, braced and cross-braced such that they cannot straddle the cross-tubes of a helicopter's skid assembly and would be unusable in many applications. Furthermore, the Pylon Ladder would be expected to provide less resistance to forward tipping than the present invention because the support legs of the Pylon Ladder do not extend beyond the bottom of the stepped legs when the ladder is in the folded position and do not make a more acute angle to the ground than do the stepped legs when the ladder is in its open, operational, position.

### SUMMARY

It is an object of the invention to devise a portable ladder that can be manipulated by one person and be placed in close proximity to a helicopter, an aircraft or to another piece of equipment.

It is an object of the invention to devise a portable ladder than can closely nest with the curved body of a helicopter and by so doing, provide ready access to a variety of surfaces and areas.

It is an object of the invention to have the ability to clear, straddle or otherwise avoid interference with portions of the aircraft to which the ladder is being placed adjacent.

It is an object of the invention to provide enhanced access to the upper portions of otherwise difficult to access parts, such as to the rotor assembly of a helicopter.

It is an object of the invention to provide enhanced stability in comparison to conventional step ladders.

It is a object of the invention to provide stepped rungs upon which a person can stand that are cantilevered with respect to the attachment point of the supporting legs.

The ladder described in this invention has two pairs of legs (commonly known as “rails”). Typically, one pair of rails is longer than the other. The longer pair is interconnected with rungs or steps and designed to be stood upon. The shorter pair of rails is interconnected with bracing and designed to provide stability. The longer pair of rails when connected with steps or rungs is hereafter referred to as the ‘stepped unit’. The shorter pair of rails when connected with bracing is hereafter referred to as the ‘support unit’.

The two units are attached to each other at a hinge-point located some distance below the top of the stepped unit. The two units are further attached to each other by a brace which can retract when the ladder is in the folded position and can extend to hold the ladder in the open position.

When in the folded position, the two units are ostensibly parallel and in close proximity to one another. In the folded position, the lower portion of the support unit extends beyond the lowest portion of the stepped unit.

When unfolded and locked in place by the side braces, the two units are held at different angles with respect to the ground. The angle of the stepped unit is typical of a conventional folding ladder. The angle of the support unit is more acute.

The hinge point is typically located within about the middle third of the stepped unit. The upper portion of the stepped unit is thus cantilevered with respect to the hinge point. The ladder is constructed of materials sufficient to permit a person to stand one or more rungs above the hinge point.

When the ladder is placed at approximately right angles to the aircraft, the curved body of the aircraft fits within the space defined by the stepped and support units. By selecting appropriate rail lengths and an appropriate attachment point location, ladders can be tailored to fit specific aircraft profiles.

### BRIEF DESCRIPTION OF THE DRAWINGS

The foregoing and other features of the invention will be apparent from the following, more particular descriptions of exemplary embodiments of the invention, as illustrated in the accompanying drawings. Like reference numbers indicate identical or functionally and/or structurally similar elements.

FIG. 1 depicts an embodiment of the support unit being hinged to the stepped unit within about the middle third of the length of the stepped unit.

FIG. 2 illustrates an embodiment of the portable ladder nesting in close proximity to a helicopter.

FIG. 3 depicts an isometric view of an embodiment of the support unit braced such that it can straddle objects between the support rails.

FIG. 3a depicts an enlarged view of the rod end ball joint used as a hinge mechanism in the embodiment shown within FIG. 3.

FIG. 4 depicts a side view of an embodiment of a portable ladder in an open position where the angle measured between the ground and the stepped unit is greater than the angle between the ground and the support unit.

FIG. 5 depicts a side view of an embodiment of a portable ladder in a folded position where the support unit extends beyond the bottom of the rails of the stepped unit.

### DETAILED DESCRIPTION OF EMBODIMENTS OF THE INVENTION

Exemplary embodiments are discussed in detail below. While specific exemplary embodiments are discussed, it should be understood that this is done for illustration purposes only. Persons skilled in the relevant art may recognize that other components and configurations may be substituted without parting from the spirit and scope of the invention. It is to be understood that each specific element includes all equivalents that operate in a similar manner to accomplish a similar purpose

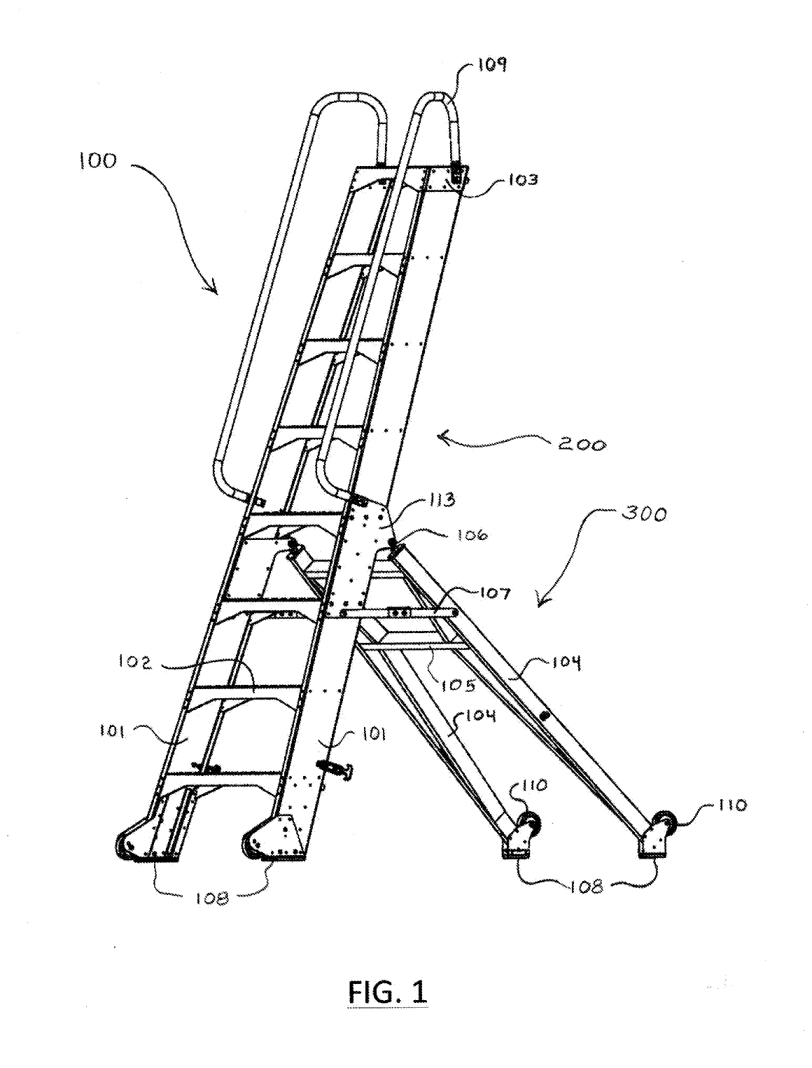

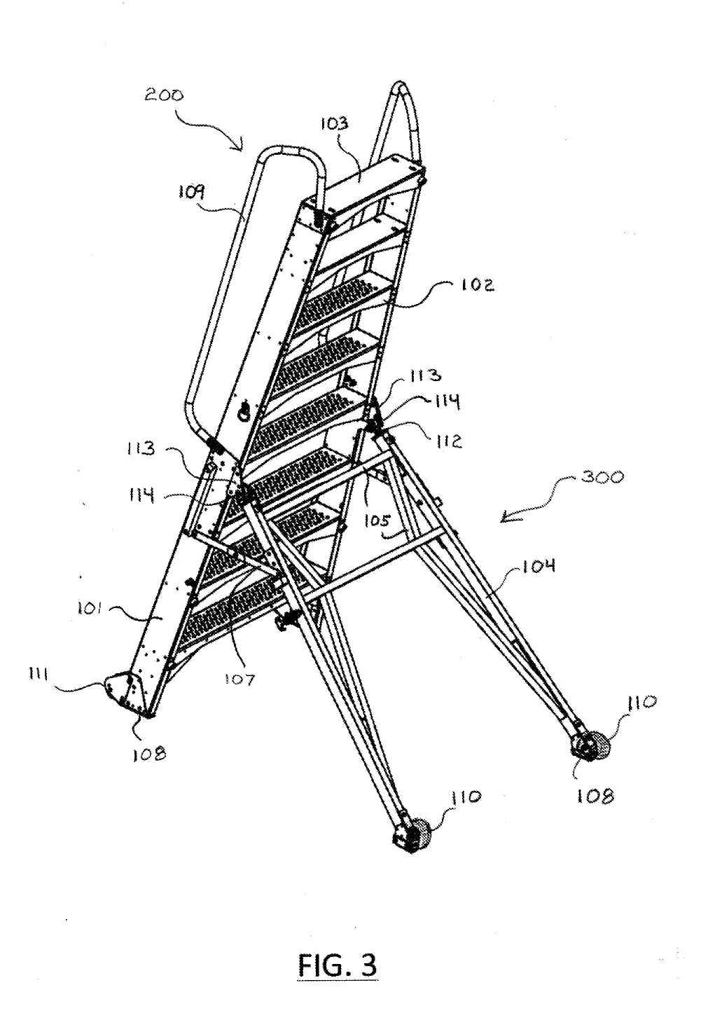

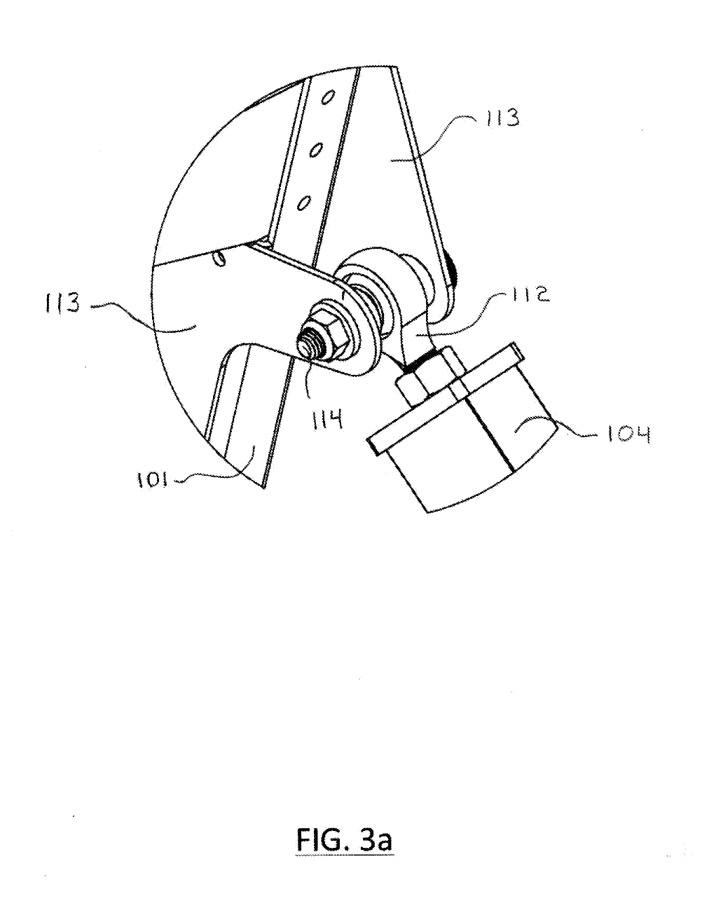

FIG. 1 Referring now to FIG. 1, a lightweight, portable, safety ladder and work platform 100 according to the first embodiment of the present invention is shown. The ladder is comprised of two pairs of rails. To one pair of rails 101 steps 102 and a top plate 103 are attached. This combination of rails, steps and top plate will be referred to as the ‘stepped unit’ 200. The other pair of rails 104 are braced 105 to each other as can most clearly be seen in FIG. 3. The combination of braced rails will be referred to as the ‘support unit’ 300. The support unit is attached to the stepped unit with hinges 106 and foldable braces 107. The length of the support rails and the location of the hinge attachment point or points along the stepped unit are variables which can be optimized for use with specific aircraft and helicopters. The bottom ends of the stepped rails 101 and the support rails 104 are fitted with pads 108 that assist in preventing the ladder from slipping. Attached to the stepped unit are a pair of handrails 109. In this embodiment, the stepped rails are further apart where they touch the ground than where they are joined at the top plate. Similarly, the support rails are further apart where they touch the ground than where they are joined to the stepped unit at the two hinge points.

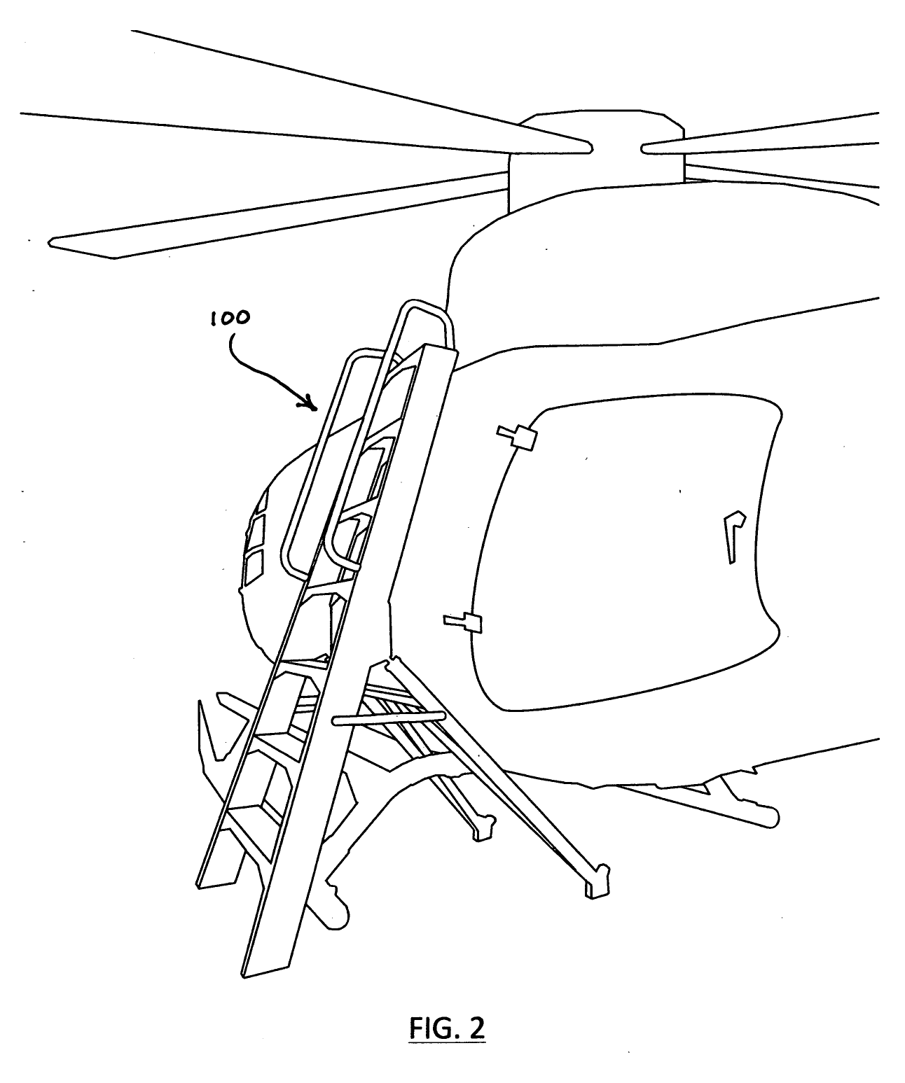

FIG. 2 illustrates an embodiment of the present invention in close proximity to an aircraft ready to be used for its intended purpose.

FIG. 3 depicts a isometric view of an embodiment of the safety ladder such that the support unit 300 is clearly visible. The support rails 104 are shown with internal bracing 105 that rigidly holds the two members and provides the structural strength necessary to meet the load requirements of the ladder. The bracing is constructed so as to leave the space between the rails empty, thus permitting the unit to fit over obstacles such as the helicopter skid cross tubes seen in FIG. 2.

The ladder depicted in FIG. 3 is fitted with wheels 110 on upward facing edges of the support rails 104 and wheels 111 the backward facing edges of the stepped rails. Such wheels can be of assistance in transporting the ladder to the work area and in positioning the ladder in proximity to the aircraft.

The stepped unit 200 and support unit 300 are interconnected through the use of two rod end ball joints 112. These rod end ball joints are better seen in the enlarged view provided in FIG. 3a.

In FIG. 3a the rod end ball joint 112 is securely attached to the top end of the support rail 104. Two brackets or plates 113 are securely attached to the stepped rail 101 in the area where the support unit and stepped unit will be joined. A securing bolt 114 passes through corresponding holes in those plates and through the eye of the rod end ball joint, thus completing the hinge assembly.

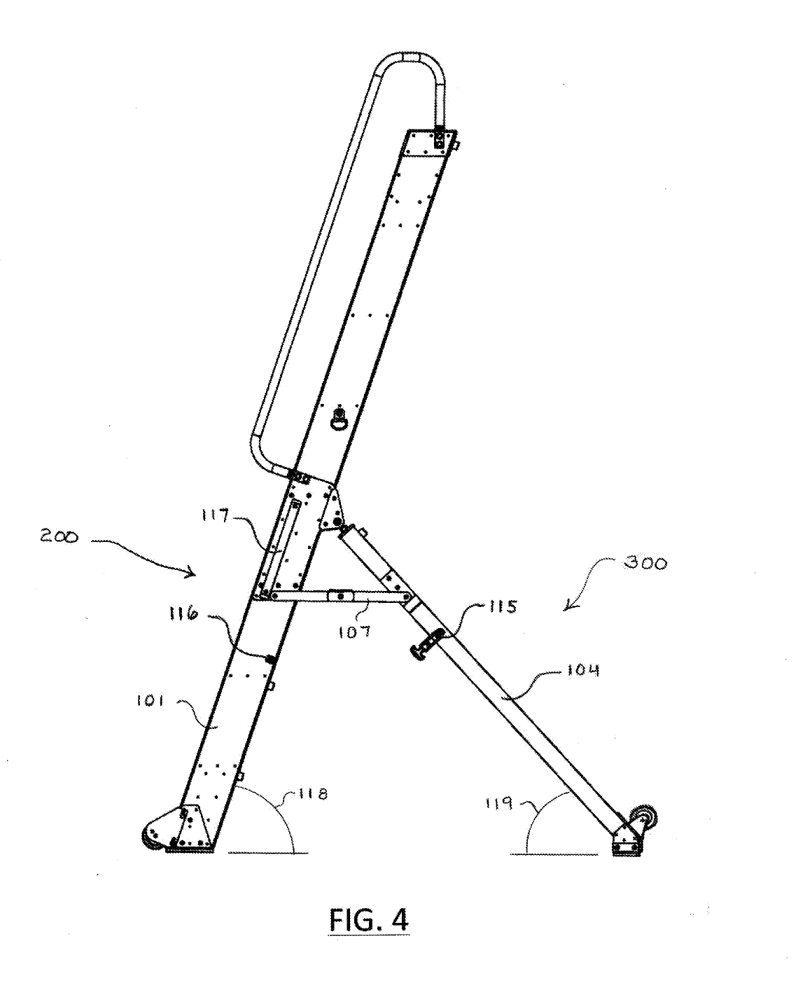

FIG. 4 depicts a side view of an embodiment of the ladder in its open position. A latching strap 115 is secured to the stepped rail 104 and a corresponding latching hook 116 is secured to the support rail 101. When the ladder is in the closed position, the latching strap and latching hook may be joined to secure the stepped unit 200 to the support unit 300. A protective bumper 117 is affixed to the stepped rail. When the ladder is in the closed position and laid on the ground upon its side, the bumper acts to protect the folding side braces 107.

In FIG. 4, it can be seen that the angle measured between the ground and the stepped rail 118 is greater than the angle measured between the ground and the support rail 119.

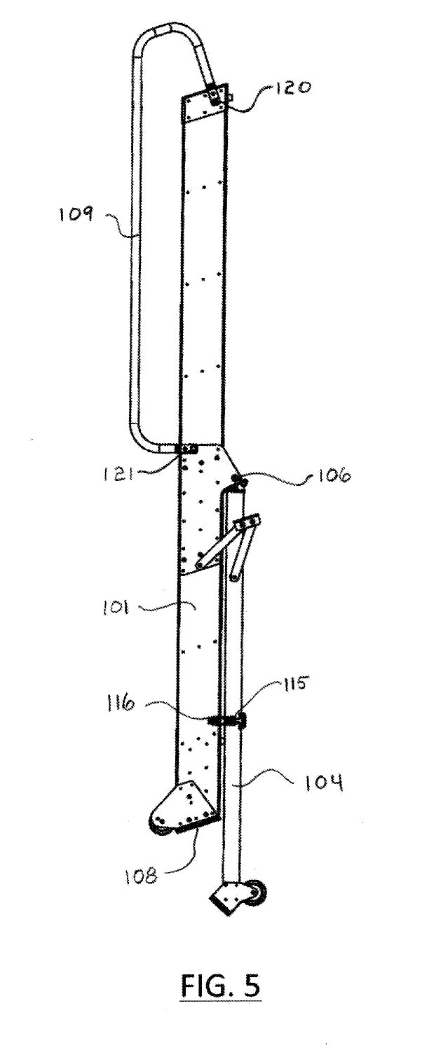

FIG. 5 depicts a side view of an embodiment of the ladder in its closed position. In this depiction, the latching strap 115 is secured to its corresponding latching hook 116 thus holding the stepped and support units together for ease of transport. In this closed and latched position, the support rails 101 are in a close and substantially parallel orientation with respect to the support rails 104, thus minimizing the space requirement for storing or transporting the ladder. The handrails 109 are secured to the stepped unit with removable bolts at attachment points 120 and 121. The handrails may be detached from the ladder by removal of the bolts, further minimizing the space requirement for storing or transporting the ladder.

In FIG. 5, it can be seen that the support legs 104 extend beyond the bottom of the stepped rails 101 and below the friction pads 108 secured to the end of those rails.

### Materials, Design Considerations and Operation

Based upon the foregoing description of the elements, their configuration and interconnection, one skilled in the art would be expected to be able to construct a lightweight portable ladder that provided the advantages possessed by described embodiments of the present invention. Described here are additional details related to the material used, design considerations and operation of the ladder.

Because safety and stability are characteristics of paramount importance, design consideration can augment the suitability of the ladder for its intended purpose. In FIGS. 1, 2, 3 and 6 embodiments of the ladder are depicted with both the support rails 104 and the stepped rails 101 being spaced wider apart at their bottom end than at their top end.

With respect to the stepped rails 101 of the stepped unit 200, the wider stance at the friction pads 108 provides additional stability. The shortening of the steps 102 which occurs as one traverses up the ladder serves to centralize the mass and to provide additional stability through those means. The narrowed stance at the upper steps further serves to bring the handrails 109 into a more convenient position to be gripped by the person standing upon the ladder.

With respect to the support rails 104 of the support unit 300, the wider stance at the friction pads 108 provides additional stability which is further enhanced owing to the fact that the support rails 104 are longer than the stepped rails as measured from the hinge point 106. Because the angle of flare is ostensibly the same for the rails of both the support unit and the stepped unit, the added length of the support rails results in the friction pads 108 of the support unit being spread still further apart. These more widely spaced foot pads act as if they were outriggers and provide enhanced stability in the lateral direction.

With further respect to the support rails 104 of the support unit, it should be apparent to those skilled in the art that their extended length provides increased resistance to tipping forward, thus allowing the ladder to support heavier loads being applied higher above the hinge point 106. In order to accommodate these higher loads and forces, the support rails 104 and support rail bracing 105 must be constructed using appropriately strong materials. High tensile strength aluminum tubing has proven to be suitable for this purpose. Various other metals, alloys, fiberglass and composites might also prove suitable.

With further respect to the issue of safety and stability, in the embodiment depicted in FIGS. 1, 2 and 3 the rails 101 and steps 102 are oversized compared to those found in conventional stepladders. These larger steps better facilitate the safety ladder and work platform functions of the present invention giving the mechanic a stronger and larger platform upon which to stand. The presence of handrails 109 further adds to the safety features of this ladder.

Persons skilled in the art understand that step ladders can be constructed using a variety of hinge mechanisms 106. Any number of hinged mechanisms that would permit the stepped unit to smoothly swing relative to the support unit could be used to construct a ladder that shared many of the advantages of the present invention. For example, a continuous hinge (commonly called a ‘piano’ hinge) could be used such that one flap is affixed to the backside of a step 102 and the other flap is affixed to bracing 105 connecting the top ends of the support rails 104. A obvious limitation of using this arrangement would be that that there are a discrete number of steps thus a limited number of structurally appropriate attachment points.

Because it is desirable to construct a helicopter maintenance ladder with optimized angles, it is important to be able to locate the hinge points wherever the design requires. It is further desirable for those hinges to operate smoothly without binding and with a minimum of free play which, if present, would permit the ladder to wiggle or shake. The limitation described for the embodiment using a continuous hinge can be overcome by using a pair of rod end ball joints 112 or functional equivalents such as spherical rod end ball joints, race linkage rod ends or rod end bearings. Such joints may be affixed to the top ends of the support rails 104 and corresponding attachment means affixed to the rails 101 of the stepped unit wherever the design requires. Alternately, attachment means may be affixed to the top end of the support rails 104 and corresponding rod end ball joints affixed to the rails 101 of the stepped unit. Such flexibility facilitates the construction of a ladder having angles optimized for its intended use. Another advantage of using paired rod end ball joints in this application is that paired joints permit ostensibly zero motion in any direction other than the desired axis of rotation. When used as the hinge element in the construction of embodiments of the present invention, rod end ball joints contribute greatly to the production of safety ladders that are exceptionally stable and secure.

With respect to moving the ladder from where it may be stored to where it will be employed, the ladder may be found to be light enough to be carried by one person. Alternatively, the ladder, preferably in its closed position as seen in FIG. 5, can be rolled to the work site using attached wheels 110 or 111. The safety hand rails 109 provide a convenient handle when pushing or pulling the ladder upon either pair of wheels.

In operation, the ladder is brought into its full open position by pivoting the rails 101 and 104 upon the hinge mechanism 106 until the folding braces 107 are fully extended. Once extended, the folding braces lock the ladder into its operational position. Once so locked the ladder is moved into its ultimate work position either by manually lifting, or tilting and then rolling it upon wheels 111, or by dragging, or by rocking it upon the friction foot pads 108 and/or by combinations thereof. As most clearly seen in FIG. 2, in order to place the ladder in its optimal work position, it may be necessary to clear, straddle or otherwise avoid contact with various portions of the aircraft or helicopter. A properly constructed embodiment of the present invention will have taken into consideration the nature and location of those obstacles and will integrate well with the aircraft for which it was designed.

To further enhance the utility of the present invention as a work platform for the maintenance of aircraft, helicopters and other machinery, the ladder may be fitted with additional accessories such as trays, tool and part holders, cup holders and the like. These accessories may be permanently attached, hung from the ladder, or attached by temporary or removable means. In an embodiment of the current invention not shown in any of the figures, the ladder is fitted with receptacles sized to receive a quart-sized can of motor oil mounted on the outboard surfaces of each of the two stepped rails 101 near the top plate 103. These receptacles provide convenient repositories for the placement of small parts when the ladder is in use and further serve as protective bumpers when the ladder is laid upon either side.

It is believed that the present invention as described and its many attendant advantages will be understood by the foregoing description. It is also believed that it will be apparent that various changes may be made in the form, construction and arrangements of the components thereof without departing from the scope and spirit of the invention and without sacrificing all of its material advantages. Thus the breadth and scope of the present invention should not be limited by any of the above-described exemplary embodiments, but should instead be defined only in accordance with the following claims and their equivalents.

What I claim is:

1. A step ladder comprising:
a. two pairs of side rails, each said side rail having a top end and a bottom end
b. one of said pairs of side rails being co-joined by means of rungs upon which a person can stand to create a unified stepped unit having a top end and a bottom end
c. the other of said pairs of side rails being braced to each other so as to create a unified support unit having a top end and a bottom end
d. hinge means connecting the said top end of the said support unit to said stepped unit such that when the ladder is in its folded configuration the said bottom end of the support unit extends beyond the bottom end of the stepped unit
e. retention means to hold said stepped unit at a predetermined angle relative to said support unit allowing the said units to be held spread apart
whereby the step ladder can be placed into and retained in a self-supporting working position.

2. The step ladder of claim 1 wherein the top end of the stepped unit extends beyond the top end of the support unit and is cantilevered with respect to that unit.

3. The step ladder of claim 1 wherein the rails of the stepped unit and the support unit are more widely spaced at their bottom ends than at their top ends.

4. A step ladder comprising:
a. two pairs of side rails, each said side rail having a top end and a bottom end
b. one of said pairs of side rails being co-joined by means of rungs upon which a person can stand to create a unified stepped unit having a top end and a bottom end
c. the other of said pairs of side rails being braced to each other so as to create a unified support unit having a top end and a bottom end
d. the said rails of the said stepped unit being angled with respect to each other such that the distance between the said bottom ends is greater than the distance between the said top ends
e. the rails of the said support unit being angled similarly to that of the said stepped unit
f. hinge means to connect said stepped unit and said support unit
g. connecting hinge means of said stepped unit to hinge means of said support unit such that the said top end of the support unit is connected to the stepped unit at a location between the said top end of the stepped unit and about two thirds of the way down the length of that unit such that when the ladder is in its folded configuration the said bottom end of the support unit extends beyond the said bottom end of the stepped unit
h. retention means to hold said stepped unit at a predetermined angle relative to said support unit allowing the said units to be held spread apart
whereby when the step ladder is placed into a self-supporting working position the bottom ends of the side rails of the support unit are spaced wider apart than are the bottom ends the side rails of the stepped unit.

5. The step ladder of claim 4 built with sufficient strength to bear the weight of a human standing one or more rungs above the hinge means.

6. The step ladder of claim 4 wherein the support unit is braced such that an object placed between the rails many be straddled.

7. The step ladder of claim 4 further including wheels attached near the base of one or both pairs of rails onto which the ladder can be tilted.

8. The step ladder of claim 4 further including friction foot pads affixed to one or both pairs of rails to impart increased slip resistance.

9. The step ladder of claim 4 further including one or more accessories selected from the group consisting of handrails, platforms, trays, cups and tool holders.

10. A step ladder comprising:
a. two pairs of side rails, each said side rail having a top end and a bottom end
b. one of said pairs of side rails being co-joined by means of rungs upon which a person can stand to create a unified stepped unit having a top end and a bottom end
c. the other of said pairs of side rails being braced to each other so as to create a unified support unit having a top end and a bottom end
d. two rod end ball joints with means for firmly securing one of said rod end ball joints to each said rail of either of said units
e. connection means firmly secured to the other of said units
f. linkage means to join rod end ball joints to connection means
g. joining said rod end ball joints to corresponding connection means by linkage means thus unifying said stepped unit to said support unit at two connection points
h. retention means to hold stepped unit at a predetermined angle relative to said support unit allowing the said units to be held spread apart
whereby the step ladder can be placed into and retained in a self-supporting working position.

11. The step ladder of claim 10 wherein the rod end ball joints are firmly secured at or near said top end of the support unit and the connection means are firmly secured to the stepped unit.

12. The step ladder of claim 10 wherein each of the rod end ball joints is firmly secured to the rails of the stepped unit and the connection means are firmly secured at or near the top end of the support unit.

13. The step ladder of claim 10 wherein the connection points are located within about the middle third of the of stepped unit as measured from the bottom end to the top end of that unit.

14. The step ladder of claim 10 wherein the lengths of each of the rails of the support unit as measured from the connection point to the bottom end of that rail are substantially equal and wherein the lengths of each of the rails of the stepped unit as measured from the connection point to the bottom end of that rail are also substantially equal.

15. The step ladder of claim 10 wherein the lengths of each of the rails of the support unit as measured from the connection point to the bottom end of that rail are substantially equal and wherein the lengths of each of the rails of the stepped unit as measured from the connection point to the bottom end of that rail are substantially equal and wherein the support rails are longer than the stepped rails when measured from the connection point to their bottom ends.

16. The step ladder of claim 10 built with sufficient strength to bear the weight of a human standing one or more rungs above the hinge means.

17. The step ladder of claim 10 wherein the support unit is braced such that an object placed between the rails many be straddled.

18. The step ladder of claim 10 further including wheels attached near the base of one or both pairs of rails onto which the ladder can be tilted.

19. The step ladder of claim 10 further including friction foot pads affixed to one or both pairs of rails to impart increased slip resistance.

20. The step ladder of claim 10 further including one or more accessories selected from the group consisting of handrails, platforms, trays, cups and tool holders.
